(19) United States
(12) Patent Application Publication
(10) Pub. No.: US 2022/0416317 A1
(43) Pub. Date: Dec. 29, 2022

(54) CONTINUOUS BATTERY FUNCTIONAL TESTING SYSTEM AND METHOD

(71) Applicant: VIVET Technology LLC, Dearborn, MI (US)

(72) Inventor: Amjad Qusay Hashem, Dearborn, MI (US)

(21) Appl. No.: 17/804,554

(22) Filed: May 27, 2022

Related U.S. Application Data
(60) Provisional application No. 63/193,641, filed on May 27, 2021.

(51) Int. Cl. H01M 10/42; H01M 10/44

(52) U.S. Cl. CPC H01M 10/4285; H01M 10/441

(57) ABSTRACT

A system may be configured for distributed functional testing of one or more batteries. The system may include a charging station, a discharging station, and an automation station in a distributed arrangement with respect to each other, having respective automation and communication devices, and being in communication with each other to separately charge, discharge, and test the one or more batteries. The automation station may be arranged in at least one of a series configuration and a parallel configuration with respect to at least one of the charging and discharging stations.

### CROSS-REFERENCE TO RELATED APPLICATION

This non-provisional patent application is based on and claims priority to U.S. Provisional Patent Application No. 63/193,641 filed May 27, 2021, which is incorporated by reference in its entirety.

### BACKGROUND

Traditional functional testing of batteries may include a stand-alone device that performs non-continuous, sequential, and time-intensive operations. Typical devices perform an overly complicated series of operations that may require considerable time to complete and are prone to system failure. Traditional systems become inoperable if an issue occurs in any portion of the series.

There is a need for the systems and methods herein that solve the above problems. There is a need for the embodiments herein that provide improved automation, charging, and discharging devices and methods. The embodiments herein may include optimized battery functional testing operations. The present disclosure provides advantages, improvements, and solutions over prior systems.

### BRIEF DESCRIPTION OF THE DRAWINGS

FIG. 1 illustrates an exemplary system of the present disclosure, e.g., for a battery functional testing system;

FIG. 2 illustrates another exemplary system of the present disclosure;

FIG. 3 illustrates another exemplary system of the present disclosure;

FIG. 4 illustrates another exemplary system of the present disclosure, e.g., a baseline configuration;

FIG. 5 illustrates another exemplary system of the present disclosure, e.g., a scalable configuration;

FIG. 6 illustrates another exemplary system of the present disclosure, e.g., a scalable configuration;

FIG. 7 illustrates another exemplary system of the present disclosure, e.g., a scalable configuration; and

FIG. 8 illustrates another exemplary system of the present disclosure, e.g., a scalable configuration.

### DETAILED DESCRIPTION

The systems and methods herein may include improved functional test cycle operations for batteries. This may include a functional testing system in a distributed arrangement of automation, charging and discharging devices and operations to minimize delays for testing and cooling associated with traditional systems. Exemplary battery functional tests may include one or more of testing a battery management system (BMS), testing a relay, performing a first charging operation, performing a first cooling delay, performing a first discharging operation, performing a second cooling delay, performing a second charging operation, performing a third cooling delay, performing a second discharging operation, and performing a functional test.

The systems herein may utilize a combination of dedicated devices for automation, charging and discharging operations in operative communication with a transport system to minimize delays for time intensive and cooling operations while increasing utilization of available devices. This may include any quantity and order of sequential or simultaneous testing, charging, cooling, and discharging operations.

The systems and methods herein may utilize respectively dedicated automation, charging and discharging devices to perform one or more operation of a battery functional test, and then a transport system may move the battery assembly to another automation, charging, or discharging device dedicated to the next operation of the battery functional test. Embodiments may optimize utilization of available automation, charging, and discharging devices while each battery assembly is undergoing time-intensive or waiting operations.

Exemplary systems may be configured for distributed battery functional testing. For example, a system may include a first charging device and a first discharging device each having an automation component and arranged as a first series pair with respective charging and discharging components. The system may include a second charging device and a second discharging device each having an automation component and arranged as a second series pair with respective charging and discharging components. The system may include a fifth charging device and a sixth discharging device arranged as a third series pair with respective charging and discharging components. The system may include the first series pair and the second series pair being in a parallel arrangement and connected in series to the third series pair.

Methods may be configured for distributed battery functional testing. For example, a method may include providing a first charging device and a first discharging device each having an automation component and arranged as a first series pair with respective charging and discharging components. The method may include providing a second charging device and a second discharging device each having an automation component and arranged as a second series pair with respective charging and discharging components. The method may include providing a fifth charging device and a sixth discharging device arranged as a third series pair with respective charging and discharging components, wherein the first series pair and the second series pair being in a parallel arrangement and connected in series to the third series pair.

The system may include operations for performing first automation, charging, and discharging operations on first and second battery assemblies by respective first and second series pairs in a parallel arrangement with each other. The system may include operations for performing second automation, charging, and discharging operations on the first and second battery assemblies by the third series pair that is series with the first and second series pairs.

The system may be arranged as an assembly or manufacturing system with various advantages and improvements over traditional platforms. These include improved throughput, cycle times, output frequencies and quantities, cost effectiveness, operational costs, space efficiency, physical footprint, build time, time-to-market, scalability, modularity, and downtime risks. The system provides improved cost efficiencies by utilizing similar operations by similar devices with common maintenance, repair and spare parts. The system is scalable by adding one or more automation, charging, and/or discharging devices. The system replaces multiple stand-alone platforms with traditional techniques. The system has a reduced physical footprint as expansion is accomplished by adding one or more devices rather than require system replacement. The system may be utilized for any product or industry using batteries, functional testing, or battery-operated components such as the automotive and aerospace industries.

Embodiments may include a system for distributed functional testing of one or more batteries. The system may include a charging station, a discharging station, and an automation station in a distributed arrangement with respect to each other, having respective automation and communication devices, and being in communication with each other to separately charge, discharge, and test the one or more batteries. The automation station may be arranged in at least one of a series configuration and a parallel configuration with respect to at least one of the charging and discharging stations.

At least one of the charging station, discharging station, and automation station may include a predefined or adaptive process according to a battery assembly or a test sequence. At least one of the series configuration and the parallel configuration may be adapted according to a predefined or adaptive product test sequence. At least one of the charging station, discharging station, and automation station may perform a battery test sequence. The battery test sequence may include a collection of operations including distributed operational subsets performed by each of the charging station, discharging station, and automation station.

The distributed arrangement of the charging station, discharging station, and automation station may include a predefined or adaptive order according to a battery assembly flow according to instructions or requirements of an operational test sequence. The distributed arrangement may be arranged according to predefined or adaptive instructions for at least one of a series arrangement and a parallel arrangement. The distributed arrangement may be arranged according to predefined or adaptive instructions according to one or more of an operation type, an operation sequence, an operation time, an assembly completion time, a test completion time, a scaling factor, or a production volume.

Embodiments may include method for distributed functional testing of one or more batteries. A method may include providing a charging station, a discharging station, and an automation station in a distributed arrangement with respect to each other, having respective automation and communication devices, and being in communication with each other. A method may include separately charging, discharging, and testing the one or more batteries. The automation station may be arranged in at least one of a series configuration and a parallel configuration with respect to at least one of the charging and discharging stations.

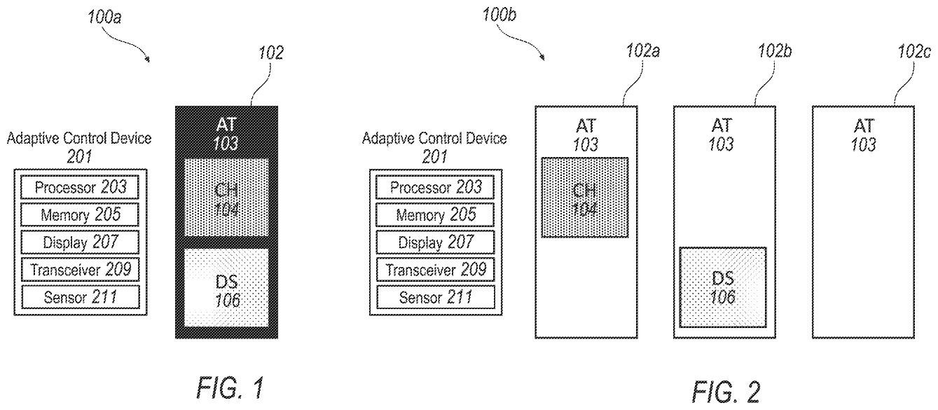

FIGS. 1-8 illustrate an exemplary system 100 for battery functional testing. System 100 may take many different forms and include multiple and/or alternate components, structures, and arrangements. While an exemplary system 100 is shown, the exemplary components are not intended to be limiting, and additional or alternative components and/or implementations may be used.

In embodiments, systems 100 (e.g., systems 100a,b,c,d,e,f,g) may be arranged and configured for battery functional testing of one or more battery assemblies. A battery assembly may include a plurality of battery components such as a battery housing, battery management system (BMS), battery cells, relays, terminals, and connections therebetween. System 100 may be configured for any battery type such as standard flooded lead-acid, absorbent glass mat (AGM), lithium ion, or a combination thereof. System 100 may be configured for vehicle batteries, e.g., automotive batteries.

System 100 may include one or more of devices 102 (e.g., devices 102a,b,c,d,e,f,g,h) and transport system 108 to move battery assemblies between respective devices 102. Device 102 may include automation (AT) device 103, charge (CH) device 104, and discharge (DS) device 106. For example, an automation device 103 may include devices configured for automated positioning and testing of battery assemblies. Charge device 104 may include one or more power sources, e.g., a high-current power supply. Discharge device 106 may include one or more power storage devices, e.g., a high-capacity power bank.

Any component of system 100 may include a hardware processor 203, physical memory 205, hardware display 207, hardware transceiver 209, sensor 211, and one or more servers, databases, and computing networks. System 100 may be configured store, communicate, display, and adapt information and transfer the information with respect to any other component therein.

As shown in FIG. 1, system 100a may include an integrated device as a unitary system. System 100a may include automation device 103, discharge device 104, and charge device 106, e.g., as an integrated arrangement. System 100a may be configured to execute operations to sequentially, periodically, and/or simultaneously activate automation device 103, discharge device 104, and charge device 106. System 100a may sequentially perform automation, discharge, and charge of one or a series of batteries. Alternatively or additionally, system 100 may perform these operations according to predefined time intervals or in response to sensor information of sensor 211.

System 100 may include one or more of devices 201 (e.g., adaptive control devices), processor 203 (e.g., hardware processor), memory 205 (e.g., physical memory), display 207 (e.g., hardware display or screen for displaying one or more user interfaces), transceiver 209 (e.g., hardware transceiver), and sensor 211. System 100 may include or be in communication with a transport system, network, server, database, or a combination thereof. Any component of system 100 may include processor 203, memory 205, display 207, and transceiver 209 configured store, communicate, display, and adapt information and transfer the information with respect to any other component thereof.

System 100 may provide information that may include or relate to any of the operations herein, by way of instructions executed by processor 203, processes, user inputs, outputs, heuristics, user interfaces, sensor information, cycle time, parts/jobs per hour, parts/jobs per year, geospatial information, location, x-y gantry, x-y-z position, proximity, time, temperature, quality, transparency, weight, part, machine and/or user information, or any combination thereof.

System 100 may communicate, by way of processor 203, memory 205, display 207, and transceiver 209, any information between one or more devices 201, servers, databases, networks, or any combination thereof. Device 201 may include an adaptive control device configured to perform one or more processing, machining, assembly and/or tooling operations including, e.g., feed tray transport, empty tray transport, assembly tray transport, stacker, operator device, x-y or x-y-z gantry, robot and/or actuator.

Device 201 may include one or a combination of computing, input-output, display and/or hardware devices such as a computer, mobile phone, smartphone, desktop, laptop, tablet, headset, handheld, watch and/or touchscreen device. System 100 may adapt by processor 203 and/or display 207 any information and operations herein. Device 201 and the transport system may include one or more sensor 211 to provide sensor information and/or to activate (e.g., trigger) any of the operations herein.

FIG. 2 illustrates system 100b including a distributed system. System 100b may include devices 102a, 102b, and 102c in a distributed arrangement. System 100b may be configured to move by transport system 108 a battery assembly to device 102a for a predefined and/or automated charging operation, and upon completion, move by transport system 108 the battery assembly to device 102b. Device 102b may be configured to perform a predefined and/or automated discharging operation, and upon completion, move by the transport system 108 the battery assembly to device 102c. Device 102c may be configured to perform a predefined and/or automated testing operation. Device 102c may be configured to return by the transport system 108 the battery to device 102 and repeat the process in response to results at or below a functional testing threshold or remove by the transport system 108 the battery from the system 100 and end the process in response to results being at or above the functional testing threshold.

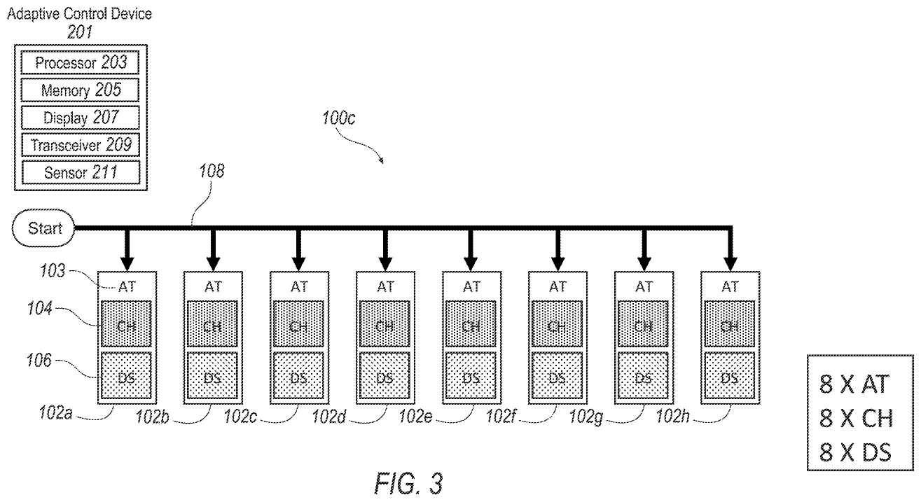

As shown in FIG. 3, system 100c includes a plurality of integrated devices 102 in a baseline arrangement. Each of devices 102a,b,c,d,e,f,g,h may include automation devices 103, discharge device 104, and charge device 106. Each of devices 102 may receive one or more battery assemblies (e.g., a single battery assembly) from transport system 108, perform each of automation, charging, and discharging operations in series, and provide the battery assembly with a results indicator for the functional battery test. System 100c may include any quantity of devices 102 with any predefined cycle time. For example, system 100c may include eight devices 102 each having a cycle time of 240 seconds, thereby averaging a functional testing completion rate of one battery assembly per 30 seconds for the baseline arrangement.

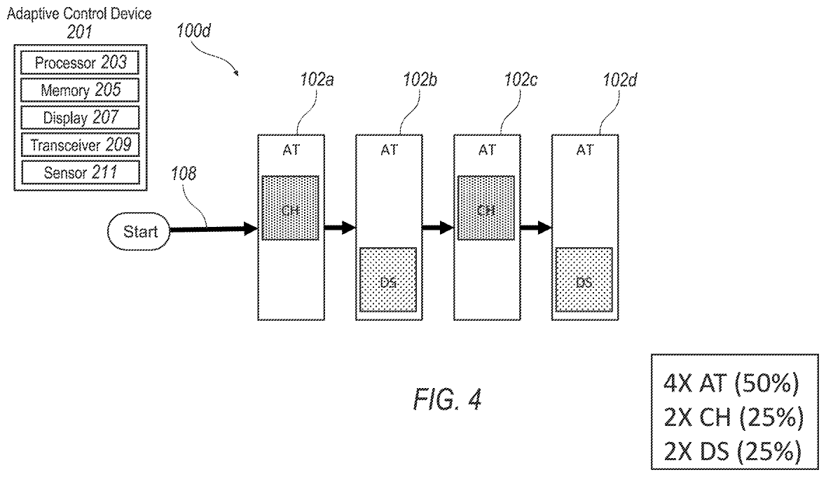

FIGS. 4-8 illustrate system 100d,e,f,g including devices 102 in various distributed arrangements. As shown in FIG. 4, system 100d may include devices 102a,b,c,d in a distributed series arrangement. Each device 102 may include automation operations. Devices 102a,b,c,d may respectively include alternating charging and discharging operations. Exemplary system 100d may include four or more automation devices 103, two or more charging devices 104, and two or more discharging devices 106, e.g., respectively representing equipment demand ratios of 50, 25, and 25 percent (%) relative to the baseline arrangement. Devices 102a,b,c,d may include corresponding cycle times of 55, 40, 25, and 30 seconds, thereby averaging a functional testing completion rate of one battery assembly per 55 seconds.

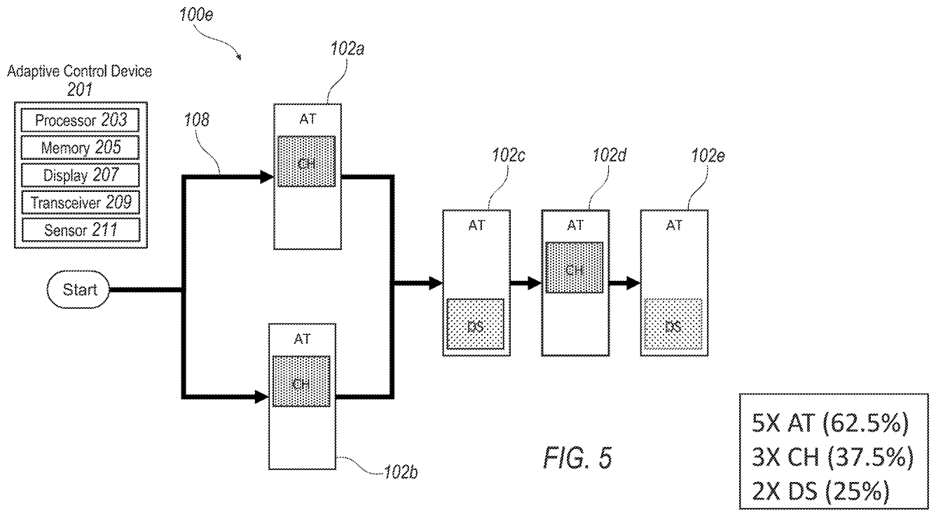

As shown in FIG. 5, system 100e may include devices 102a,b,c,d,e distributed in a hybrid parallel-series arrangement. Each device 102 may include automation operations. Devices 102a and 102b may be in a parallel arrangement and include charging operations, and connected to devices 102c,d,e in a series arrangement of alternating discharging and charging operations. Exemplary system 100e may include five or more automation devices 103, three or more charging devices 104, and two or more discharging devices 106, e.g., respectively representing equipment demand ratios of 62.5, 37.5, and 25 percent (%) relative to the baseline arrangement. Devices 102a,b,c,d,e many include respective cycle times of 55, 55, 40, 25, and 30 seconds, thereby averaging a functional testing completion rate of one battery assembly per 40 seconds.

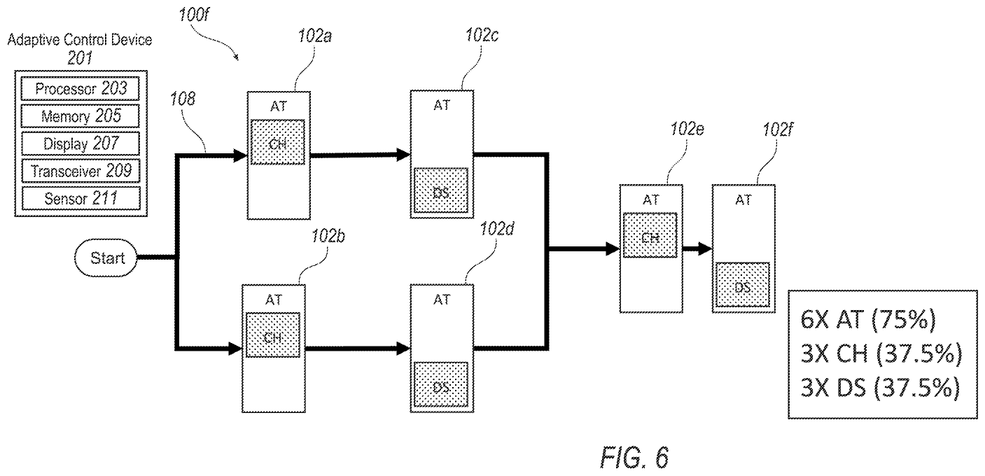

FIG. 6 illustrates system 100f that may include devices 102a,b,c,d,e,f distributed in another hybrid parallel-series arrangement. Each device 102 may include automation operations. Devices 102a,c and 102b,d may be in parallel arrangement of pairs having alternating charging and discharging operations, and connected to devices 102e,f in a series arrangement of alternating charging and discharging operations. Exemplary system 100e may include six or more automation devices 103, three or more charging devices 104, and three or more discharging devices 106, e.g., respectively representing equipment demand ratios of 75, 37.5, and 37.5 percent (%) relative to the baseline arrangement. Devices 102a,b,c,d,e,f many include respective cycle times of 55, 55, 40, 40, 25, and 30 seconds, thereby averaging a functional testing completion rate of one battery assembly per 30 seconds.

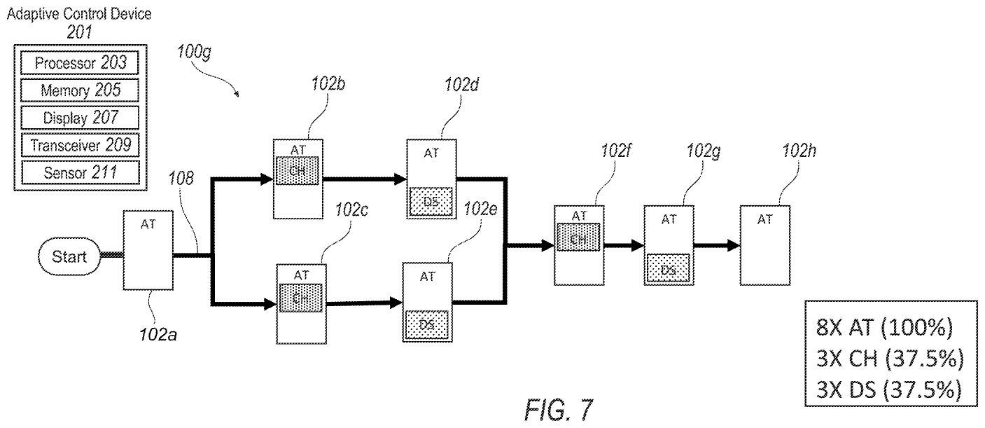

FIG. 7 illustrates system 100g that may include devices a,b,c,d,e,f,g,h in another hybrid parallel-series arrangement. Each device 102 may include automation operations. Devices 102b, d and 102c,e may be in a parallel arrangement of pairs having alternating charging and discharging operations, and connected to devices 102f,g,h in a series arrangement of alternating charging, discharging and automation operations. Exemplary system 100g may include eight or more automation devices 103, three or more charging devices 104, and three or more discharging devices 106, e.g., respectively representing equipment demand ratios of 100, 37.5, and 37.5 percent (%) relative to the baseline arrangement. Devices 102a,b,c,d,e,f,g,h many include respective cycle times of 15, 40, 40, 40, 40, 25, 25, and 5 seconds, thereby averaging a functional testing completion rate of one battery assembly per 25 seconds.

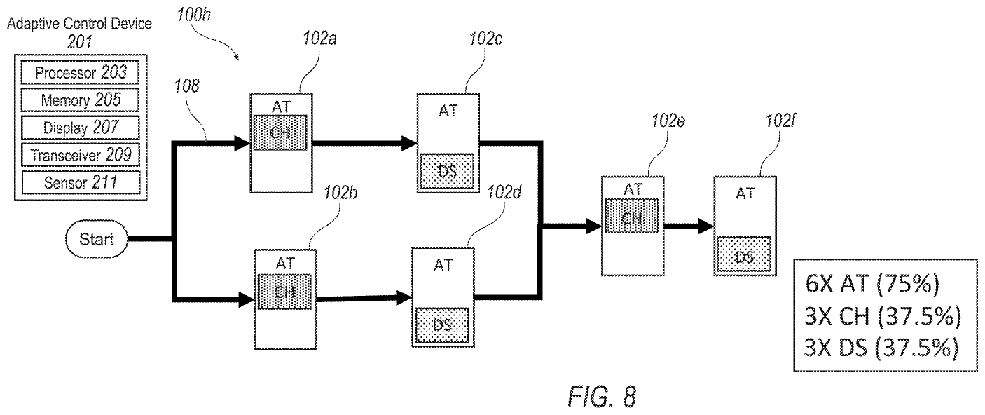

FIG. 8 illustrates system 100h that may include devices 102a,b,c,d,e,f in another hybrid parallel-series arrangement. Each device 102 may include automation operations. Devices 102a, c and 102b,d may be in parallel arrangement of pairs having alternating charging and discharging operations, and connected to devices 102e,f in a series arrangement of alternating charging and discharging operations. Exemplary system 100g may include six or more automation devices 103, three or more charging devices 104, and three or more discharging devices 106, e.g., respectively representing equipment demand ratios of 75, 37.5, and 37.5 percent (%) relative to the baseline arrangement. Exemplary devices 102a,b,c,d,e,f many include respective cycle times of 55, 55, 40, 40, 25, and 30 seconds, thereby averaging a functional testing completion rate of one battery assembly per 30 seconds.

System 100 may provide information that may include or relate to any of the operations herein, instructions executed by the processor, in response to one or more user inputs, outputs, heuristics, user interfaces, sensor information, cycle time, parts/jobs per hour, parts/jobs per year, geospatial information, location, x-y gantry, x-y-z position, proximity, time, temperature, quality, transparency, weight, part, machine and/or user information, or any combination thereof.

System 100 may communicate, by way of the processor, memory, display, transceiver, and network, any information between one or more device 102, display, server, database, or any combination thereof. Transport system 108 any machine configured to perform one or more processing, machining, assembly and/or tooling operations including, e.g., feed tray transport, empty tray transport, assembly tray transport, stacker, operator device, x-y or x-y-z gantry, robot and/or actuator. The display may include one or a combination of computing, input-output, display and/or hardware devices such as a computer, mobile phone, smartphone, desktop, laptop, tablet, headset, handheld, watch and/or touchscreen device. System 100 may adapt by the processor and/or display any information and operations herein. Devices 102 and transport system 108 may include one or more sensor to provide sensor information and/or to trigger any of the operations herein, e.g., identify respective parts having completed, defective and unfinished layers.

Transport system 108 may be configured to add, remove, and position parts for a predefined number of operations for battery functional testing by respective devices 102. Transport system 108 may include a stacker, operator device, x-y or x-y-z gantry, robot and/or actuator. Transport system 108 may be configured to identify finished, defective, and unfinished parts by sensor, transfer completed parts to a finished container or defective parts to a discard container (e.g., empty tray transport), and maintain unfinished parts on transport system 108 for a next or additional battery functional testing by system 100 and devices 102.

This disclosure is intended to be illustrative and not restrictive. All or any portion of the systems, devices, processes, methods, and steps herein may be used in combination, occur in any arrangement, order, or sequence, or occur simultaneously. Any components or steps may be added, omitted, or duplicated. The descriptions herein are provided to illustrate certain embodiments and do not limit the claims.

Many embodiments and applications other than the examples provided would be apparent to an artisan in light of this disclosure. The scope should be determined, not with reference to the above description, but should instead be determined with reference to the appended claims, along with the full scope of equivalents to which such claims are entitled. Future developments will occur in the technologies discussed herein, and the disclosed systems and methods will be incorporated into such future embodiments. The embodiments herein are capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure, and shall not be used to interpret or limit the scope or meaning of the claims. Features may be grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A system for distributed functional testing of one or more batteries, the system comprising:
a charging station, a discharging station, and an automation station in a distributed arrangement with respect to each other, having respective automation and communication devices, and being in communication with each other to separately charge, discharge, and test the one or more batteries,
wherein automation station arranged in at least one of a series configuration and a parallel configuration with respect to at least one of the charging and discharging stations.

2. The system of claim 1, wherein at least one of the charging station, discharging station, and automation station includes a predefined or adaptive process according to a battery assembly or a test sequence.

3. The system of claim 1, wherein the at least one of the series configuration and the parallel configuration is adapted according to a predefined or adaptive product test sequence.

4. The system of claim 1, wherein at least one of the charging station, discharging station, and automation station performs a battery test sequence.

5. The system of claim 1, wherein the battery test sequence includes a collection of operations including distributed operational subsets performed by each of the charging station, discharging station, and automation station.

6. The system of claim 1, wherein the distributed arrangement of the charging station, discharging station, and automation station includes a predefined or adaptive order according to a battery assembly flow according to instructions or requirements of an operational test sequence.

7. The system of claim 1, wherein the distributed arrangement of the charging station, discharging station, and automation station is arranged according to predefined or adaptive instructions for at least one of a series arrangement and a parallel arrangement.

8. The system of claim 1, wherein the distributed arrangement of the charging station, discharging station, and automation station is arranged according to predefined or adaptive instructions according to one or more of an operation type, an operation sequence, an operation time, an assembly completion time, a test completion time, a scaling factor, or a production volume.

9. A method for distributed functional testing of one or more batteries, the method comprising:
providing a charging station, a discharging station, and an automation station in a distributed arrangement with respect to each other, having respective automation and communication devices, and being in communication with each other; and
separately charging, discharging, and testing the one or more batteries, wherein automation station arranged in at least one of a series configuration and a parallel configuration with respect to at least one of the charging and discharging stations.

10. The method of claim 9, wherein at least one of the charging station, discharging station, and automation station includes a predefined or adaptive process according to a battery assembly or a test sequence.

11. The method of claim 9, wherein the at least one of the series configuration and the parallel configuration is adapted according to a predefined or adaptive product test sequence.

12. The method of claim 9, wherein at least one of the charging station, discharging station, and automation station performs a battery test sequence.

13. The method of claim 9, wherein the battery test sequence includes a collection of operations including distributed operational subsets performed by each of the charging station, discharging station, and automation station.

14. The method of claim 9, wherein the distributed arrangement of the charging station, discharging station, and automation station includes a predefined or adaptive order according to a battery assembly flow according to instructions or requirements of a operational test sequence.

15. The method of claim 9, wherein the distributed arrangement of the charging station, discharging station, and automation station is arranged according to predefined or adaptive instructions for at least one of a series arrangement and a parallel arrangement.

16. The method of claim 9, wherein the distributed arrangement of the charging station, discharging station, and automation station is arranged according to predefined or adaptive instructions according to one or more of an operation type, an operation sequence, an operation time, an assembly completion time, a test completion time, a scaling factor, or a production volume.

17. A system for distributed functional testing of one or more batteries, the system comprising:
a charging station, a discharging station, and an automation station being in communication with each other to separately charge, discharge, and test the one or more batteries,
wherein automation station arranged in at least one of a series configuration and a parallel configuration with respect to at least one of the charging and discharging stations.

18. The system of claim 17, wherein at least one of the charging station, discharging station, and automation station includes a predefined or adaptive process according to a battery assembly or a test sequence.

19. The system of claim 17, wherein the at least one of the series configuration and the parallel configuration is adapted according to a predefined or adaptive product test sequence.

20. The system of claim 17, wherein at least one of the charging station, discharging station, and automation station performs a battery test sequence.
